(19) United States
(12) Patent Application Publication
(10) Pub. No.: US 2007/0220758 A1
(43) Pub. Date: Sep. 27, 2007

(54) Utility knife

(75) Inventor: Chun-Feng Ho, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Chi-Whi Industrial Inc., Taichung Hsien (TW)

(21) Appl. No.: 11/723,811

(22) Filed: Mar. 22, 2007

(30) Foreign Application Priority Data
Mar. 23, 2006 (TW) 95110111

(51) Int. Cl. B26B 1/08

(52) U.S. Cl. 30/162; 30/125

(57) ABSTRACT

A utility knife includes a housing, a cutter holder, a cutter blade magazine and an elastic member. The housing has a front chamber, a rear chamber in communication with the front chamber, and an opening extending from the rear chamber to the outside. The cutter holder is mounted in the front chamber. The cutter blade magazine is inserted through the opening of the housing into the rear chamber. The cutter blade magazine has a cutter blade chamber for accommodating a plurality of cutter blades, a sliding slot, an elongated slot, an outlet in communication between the cutter blade chamber and the front chamber of the housing, and a push block slidably mounted in the cutter blade chamber. The elastic member has one end fastened to the inside of the rear chamber and the other end inserted through the elongated slot of the cutter blade magazine into the cutter blade chamber for stopping against cutter blades inside the cutter blade chamber. Thus, the utility knife of the invention allows for storage of multiple replacement cutter blades and also allows for safety and easy cutter blade replacement.

### BACKGROUND OF THE INVENTION

1. Field of the Invention

The present invention relates to utility knifes and more particularly, to such a utility knife that allows for storage of multiple replacement cutter blades and also allows for safety and easy cutter blade replacement.

2. Description of the Related Art

A utility knife generally comprises a housing, a cutter holder mounted in the housing and movable forwards and backwards along a sliding track in the housing to extend a cutter blade out of the housing or to receive the cutter blade inside the housing. However, the cutter blade wears quickly with use. For ease of use, a cutter blade magazine type utility knife is developed. A cutter blade magazine type utility knife has replacement cutter blades stored in a storage compartment inside the housing. When the cutter blade at the cutter holder is damaged, the user can push the cutter holder to the front side, and then use a cutter blade unloading device to remove the cutter blade from the cutter holder, and then move the cutter holder backwards into position for enabling one replacement cutter blade to be forced into the cutter holder by a spring member to complete the cutter blade replacement operation.

Due to limited inside space of the housing, the storage compartment can only receive about 8 pcs replacement cutter blades. This number of replacement cutter blades is sufficient for home application but not for professional application. When the storage compartment is empty, the user must detach the housing and insert new replacement cutter blades into the storage compartment one by one manually. This new replacement cutter blade loading procedure is complicated and may cause accidental injury.

### SUMMARY OF THE INVENTION

The present invention has been accomplished under the circumstances in view. It is one object of the present invention to provide a utility knife, which allows for storage of a big number of replacement cutter blades and also allows for easy and safe cutter blade replacement.

To achieve this and other objects of the present invention, the utility knife comprises a housing, a cutter holder, a cutter blade magazine, and an elastic member.

The housing has a front chamber, an elongated hole in communication between the front chamber and the space outside the housing, a cutter blade outlet in communication between the front chamber and the space outside the housing, a rear chamber in communication with the front chamber, and an opening in communication between the rear chamber and the space outside the housing. The cutter holder has a holder base mounted in the front chamber of the housing for carrying a cutter blade, and a suspension arm extending from the holder base to the outside of the housing through the elongated hole. The cutter blade magazine is inserted through the opening of the housing into the rear chamber. The cutter blade magazine has a cutter blade chamber for accommodating a predetermined number of cutter blades, a sliding slot in communication between the cutter blade chamber and the space outside the cutter blade magazine, an elongated slot in communication between the cutter blade chamber and the rear chamber of the housing, an outlet in communication between the cutter blade chamber and the front chamber of the housing, and a push block mounted in the cutter blade chamber. The push block has a block body movably positioned in the cutter blade chamber of the cutter blade magazine, and a control knob extending from the block body and received in the sliding slot of the cutter blade magazine for moving the push block along the sliding slot. The elastic member is mounted in the rear chamber of the housing. The elastic member has a first end fastened to the housing and a second end inserted through the elongated slot of the cutter blade magazine into the cutter blade chamber for stopping against storage cutter blades.

### BRIEF DESCRIPTION OF THE DRAWINGS

FIG. 1 is a front view of a utility knife in accordance with a first embodiment of the present invention.

FIG. 2 is a top view of the utility knife in accordance with the first embodiment of the present invention.

FIG. 3 is a side view of the utility knife in accordance with the first embodiment of the present invention.

FIG. 4 is a front view of the cutter blade magazine of the utility knife in accordance with the first embodiment of the present invention.

FIG. 5 is a schematic drawing of a part of the present invention, showing the cutter blade magazine of the utility knife in action.

FIG. 6 is a schematic drawing of the present invention, showing the utility knife in action (I).

FIG. 7 is a schematic drawing of the present invention, showing the utility knife in action (II).

FIG. 8 is a schematic drawing of the present invention, showing the utility knife in action (III).

FIG. 9 is a front view of FIG. 8.

FIG. 10 is a schematic drawing of the present invention, showing the utility knife in action (IV).

FIG. 11 is a schematic drawing of the present invention, showing the utility knife in action (V).

FIG. 12 is a schematic side view of FIG. 11.

### DETAILED DESCRIPTION OF THE INVENTION

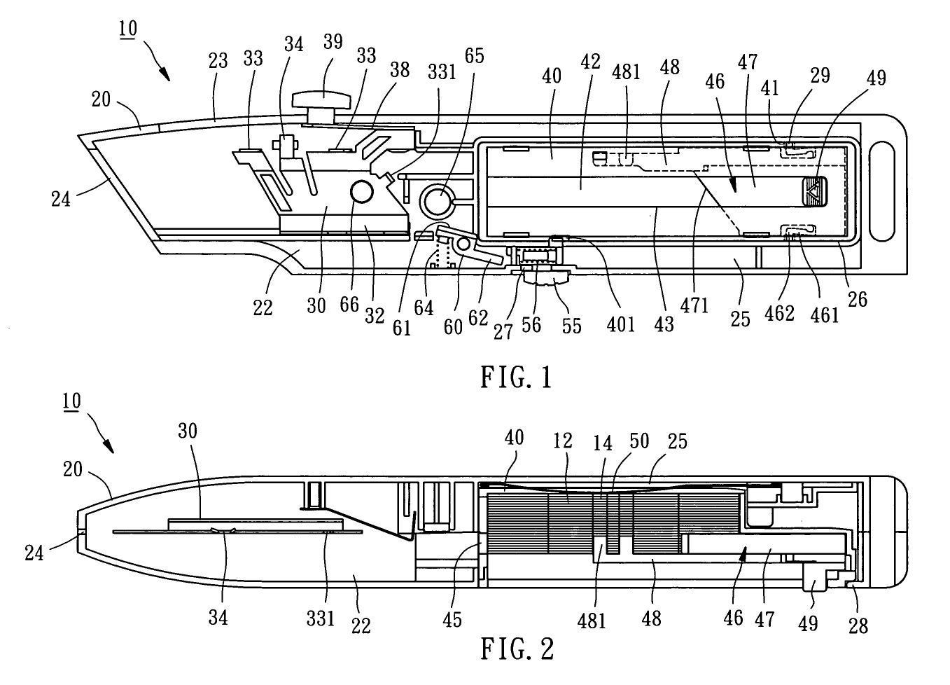

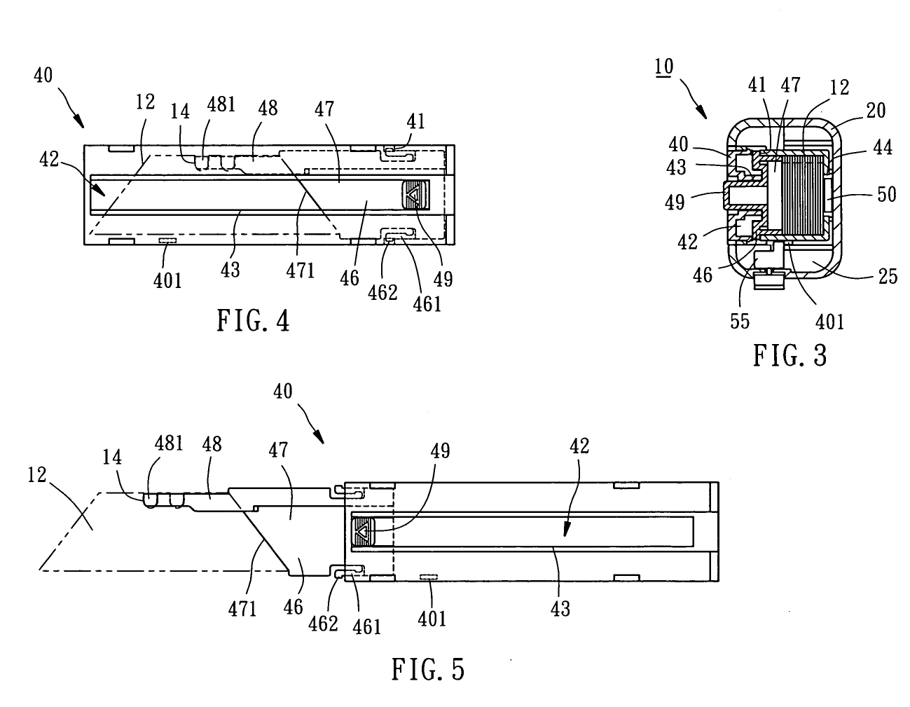

Referring to FIGS. 1˜3, a utility knife 10 in accordance with the first embodiment of the present invention is shown comprised of a housing 20, a cutter holder 30, a cutter blade magazine 40, an elastic member 50, a safety button 55, a retaining member 60, a first magnetic member 65, a second magnetic member 66, a first spring plate 68, a second spring plate 70, and a third spring plate 74.

The housing 20 has a front chamber 22, an elongated hole 23 provided on the top side of the housing 20 in communication between the front chamber 22 and the outside space, a cutter blade outlet 24 provided on the front end of the housing 20 in communication between the front chamber 22 and the outside space, a rear chamber 25 in communication with the front chamber 22, an opening 26 provided on one side of the housing 20 in communication between the rear chamber 25 and the outside space, a short hole 27 provided on the bottom side of the housing 20 in communication between the rear chamber 25 and the outside space, and a stop flange 28 disposed at one end of the opening 26.

The cutter holder 30 has a holder base 32 mounted in the front chamber 22 of the housing 20 for holding one cutter blade 12, a suspension arm 38 extending from the holder base 32 to the outside of the housing 20 through the elongated hole 23, a plurality of ribs 33 protruded from a periphery of the holder base 32 for securing one cutter blade 12 to the holder base 32, a retaining strip 34 obliquely upwardly extending from the holder base 32 for engaging into one locating hole 14 on one cutter blade 12 to secure the cutter blade 12 to the holder base 32, and a knob 39 extending from the free end of the suspension arm 38 for operation by the user to move the cutter holder 30 forwards or backwards relative to the housing 20. By means of the aforesaid arrangement, one cutter blade 12 can firmly be secured to the cutter holder 30 and moved with the cutter holder 30 in and out of the housing 20 through the cutter blade outlet 24.

The cutter blade magazine 40 is inserted through the opening 26 into the rear chamber 25 of the housing 20. The cutter blade magazine 40 has a cutter blade chamber 42 that accommodates a certain number of replacement cutter blades 12, a sliding slot 43 in communication between the cutter blade chamber 42 and the outside space, an elongated slot 44 in communication between the cutter blade chamber 42 of the cutter blade magazine 40 and the rear chamber 25 of the housing 20, an outlet 45 in communication between the cutter blade chamber 42 of the cutter blade magazine 40 and the front chamber 22 of the housing 20, and a push block 46 slidably mounted in the cutter blade chamber 42. The push block 46 has a block body 47 slidably positioned in the cutter blade chamber 42 of the cutter blade magazine 40, a support arm 48 extending from the block body 47, two locating rods 481 laterally extended from the support arm 48 and respectively inserted into two retaining holes 14 of the replacement cutter blades 12 that are accommodated in the cutter blade magazine 40, and a control knob 49 extending from one side of the block body 47 and received in the sliding slot 43 of the cutter blade magazine 40. The block body 47 of the push block 46 has a beveled surface 471 stopped at one side of the replacement cutter blades 12. By means of the control knob 49, the user can move the push block 46 to push the replacement cutter blades 12 out of the cutter blade magazine 40 through the outlet 45 into the front chamber 22 of the housing 20. Further, the width of the block body 47 of the push block 46 is about equal to the combined thickness of 8 pcs replacement cutter blades 12. The length of the locating rods 481 is also about equal to the combined thickness of 8 pcs replacement cutter blades 12. Therefore, the push block 46 can deliver 8 pcs replacement cutter blades 12 at a time, as shown in FIG. 5.

Further, to prevent escaping of replacement cutter blades 12 out of the outlet 45 before insertion of the cutter blade magazine 40 into the housing 20, the push block 46 has two elastically deformable positioning arms 461 respectively extending from the top and bottom sides of the block body 47, as shown in FIG. 4. The two positioning arms 461 each are terminating in a protruding portion 462. The cutter blade magazine 40 has two holes 41 for receiving the protruding portions 462 of the positioning arms 461 to secure the push block 46 to the cutter blade magazine 40 and to prevent escaping of the replacement cutter blades 12 accidentally. When the cutter blade magazine 40 is inserted into the rear chamber 25 of the housing 20, the protruding portions 462 of the positioning arms 461 of the push block 46 are respectively stopped against two ribs 29 inside the housing 20 and deformed, and therefore the positioning arms 461 of the push block 46 are disengaged from the two holes 41 of the cutter blade magazine 40, allowing movement of the push block 46 relative to the cutter blade magazine 40.

The elastic member 50 is mounted in the rear chamber 25 of the housing 20. The elastic member 50 has a first end fastened to the housing 20 and a second end inserted through the elongated slot 44 of the cutter blade magazine 40 into the cutter blade chamber 42. When replacement cutter blades 12 are accommodated in the cutter blade chamber 42 of the cutter blade magazine 40, the elastic member 50 is stopped at one side of the replacement cutter blades 12, as shown in FIG. 2. When the cutter blade magazine 40 is empty, the elastic member 50 is stopped against the inside wall of the cutter blade magazine 40 directly, as shown in FIG. 11.

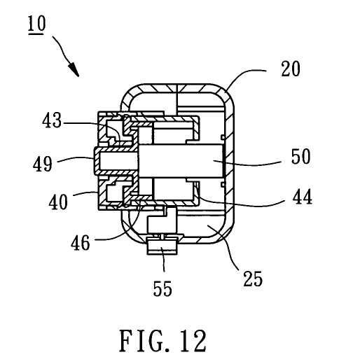

The cutter blade magazine 40 is detachably fastened to the housing 20. As shown in FIGS. 1˜3, the right side of the cutter blade magazine 40 is stopped in place by the stop flanges 28 of the housing 20. Further, the cutter blade magazine 40 has a protruding portion 401 near its left end. The safety button 55 is mounted in the rear chamber 25 of the housing 20 and extending to the outside of the housing 20 through the short hole 27. Further, the first spring member 56 is provided between the safety button 55 and the housing 20 to force the safety button 55 rightwards, forcing the safety button 55 to stop against the outer side of the protruding portion 401 of the cutter blade magazine 40. Thus, the cutter blade magazine 40 is secured to the housing 20. On the contrary, when wishing to remove the cutter blade magazine 40 from the housing 20, pull the safety button 55 leftward to release the protruding portion 401 of the cutter blade magazine 40 from the constraint, allowing the spring force of the elastic member 50 to eject the cutter blade magazine 40 out of the housing 20, as shown in FIGS. 11 and 12.

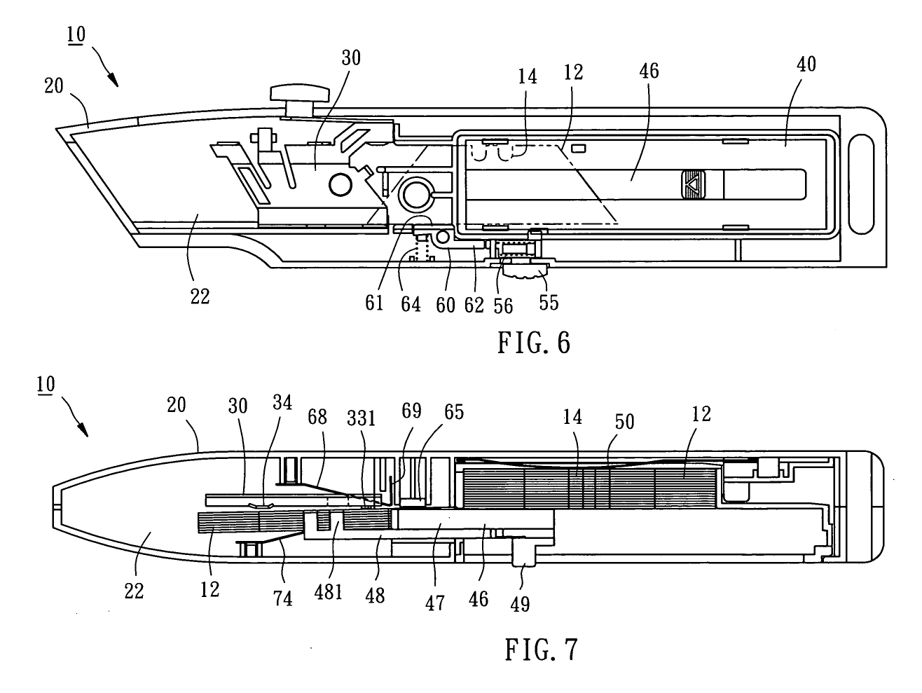

The retaining member 60 is pivotally mounted on the housing 20, and swingable between a first position (see FIG. 1) and a second position (see FIG. 6). A second spring member 64 is provided between the housing 20 and the retaining member 60. When the retaining member 60 receives no force, the second spring member 64 biases the retaining member 60 in the first position. The retaining member 60 has a guide face 61 and an extension arm 62. When the user moves the push block 46 to push replacement cutter blades 12 out of the cutter blade magazine 40, the replacement cutter blades 12 impart a pressure to the guide face 61 of the retaining member 60 to rotate the retaining member 60 from the first position to the second position, the extension arm 62 being stopped against the safety button 55 to prevent accidental triggering of the cutter blade magazine 40 by the safety button 55.

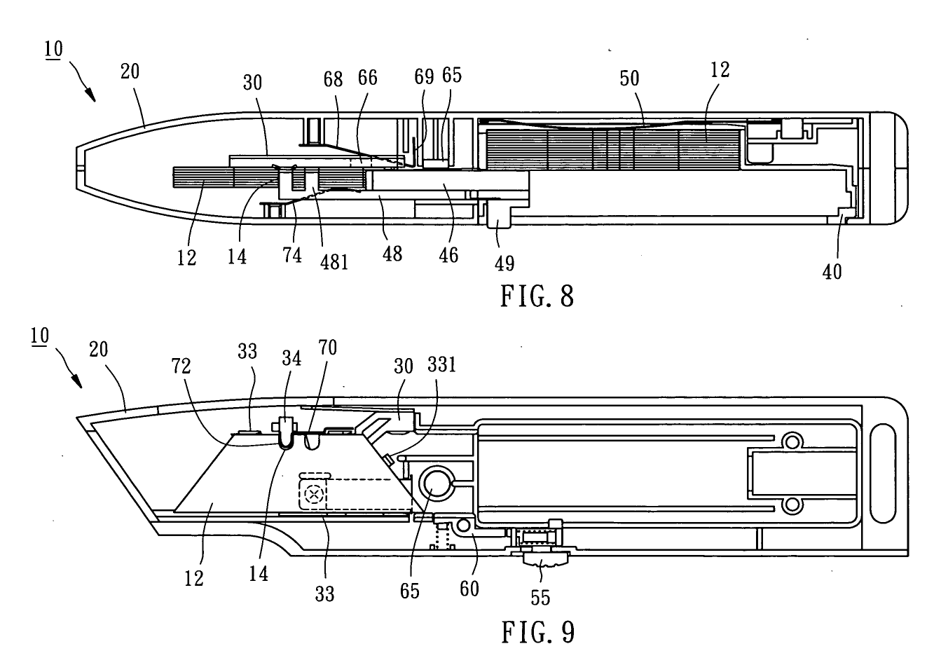

The first magnetic member 65 is mounted between the front chamber 22 and rear chamber 25 of the housing 20, as shown in FIG. 8. When the push block 46 is moved to push replacement cutter blades 12 forwards, the replacement cutter blades 12 are originally kept in parallel to the holder base 32 of the cutter holder 30. When the replacement cutter blades 12 are moved out of the cutter blade magazine 40 to the position in FIG. 7, the first magnetic member 65 attracts the replacement cutter blades 12, causing the replacement cutter blades 12 to turn about the rear rib 331 of the cutter holder 30, and therefore the front end of the delivered stack of replacement cutter blades 12 is lifted and passed over the retaining strip 34 of the cutter holder 30. When the replacement cutter blades 12 are moved to the predetermined position, the third spring plate 74 mounted in the housing 20 forces the replacement cutter blades 12 against the holder base 32 of the cutter holder 30. Further, the second magnetic member 66 is mounted on the holder base 32 of the cutter holder 30 to attract the closest replacement cutter blade 12 to stop against the holder base 32.

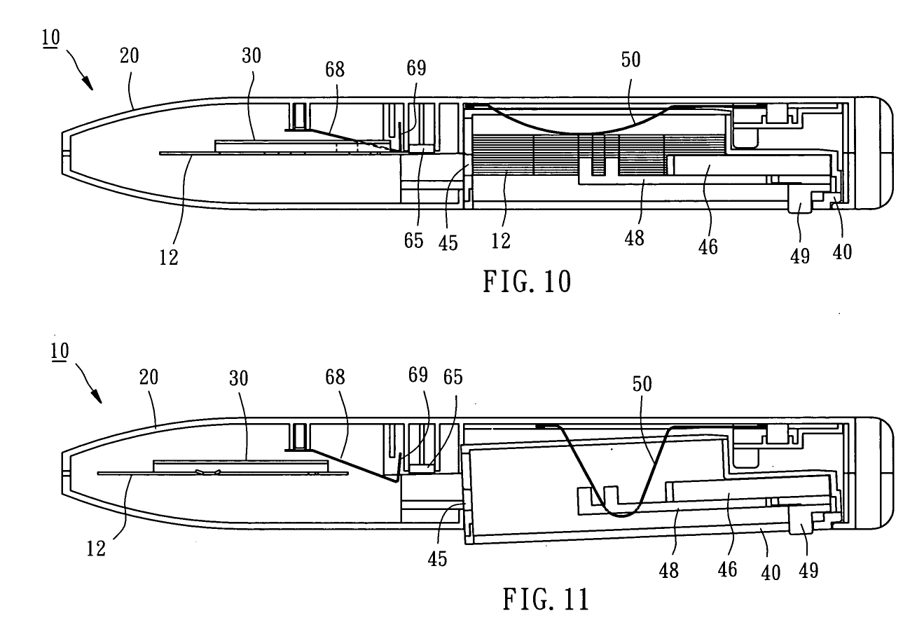

The first spring plate 68 is mounted in the front chamber 22 of the housing 20, having its front end fastened to the housing 20 and its rear end terminating in an L-shaped transverse extension portion 69, as shown in FIG. 10. When the cutter holder 30 is moved to the most rear position, the first spring plate 68 is compressed and deformed by the cutter holder 30. At this time, the user can drive the push block 46 to move the replacement cutter blades 12 forwards. On the contrary, when the cutter holder 30 is moved to the front side as shown in FIG. 2, the first spring plate 68 is released from the cutter holder 30 and allowed to lift upwards. At this time, the L-shaped transverse extension portion 69 is in the path of the replacement cutter blades 12 to prohibit forward movement of the replacement cutter blades 12. Therefore, when the cutter holder 30 is not moved into position (the most rear position), the push block 46 cannot move the replacement cutter blades 12 forwards.

The second spring plate 70 is mounted in the front chamber 22 of the housing 20, having its rear end fastened to the housing 20 and its front end terminating in a U-shaped retaining portion 72 for engaging into the locating hole 14 on each replacement cutter blade 12. Therefore, when the push block 46 pushed 8 pcs replacement cutter blades 12 into predetermined position, the second spring plate 70 holds the replacement cutter blades 12 and the push block 46 in position, as shown in FIG. 9. At this time, the push block 46 stops the remaining replacement cutter blades 12 in the cutter blade magazine 40 against the force of the elastic member 50, as shown in FIG. 8, therefore the remaining replacement cutter blades 12 in the cutter blade magazine 40 do not hinder backward movement of the push block 46 into the inside of the cutter blade magazine 40. The third spring plate 74 is stopped against the replacement cutter blades 12 that have been moved to the front chamber 22. When the cutter blade 12 under use is damaged and removed from the cutter holder 30, the third spring plate 74 forces the stack of replacement cutter blades 12 in the front chamber 22 toward the cutter holder 30, and therefore one replacement cutter blade 12 is forced into engagement with the cutter holder 30 for working. When the replacement cutter blades 12 in the front chamber 22 are used up and disengaged with the second spring plate 70, the push block 46 is capable of moving backwards into the inside of the cutter blade magazine 40, and the elastic member 50 forces 8 pcs cutter blades 12 into engagement with the push block 46 again, as shown in FIG. 10.

In actual use, the user uses a knob 39 provided on the suspension arm 38 of the cutter holder 30 to control forward or backward movement of the cutter holder 30. When moving the cutter holder 30 forwards, the cutter blade 12 that is carried on the cutter holder 30 is extended out of the housing 20. When the cutter blade 12 that is carried on the cutter holder 30 is damaged, uses a cutter release mechanism (not shown) to release the cutter blade 12 from the cutter holder 30, and then move the cutter holder 30 backwards to the position shown in FIG. 1, enabling the third spring plate 74 to force one replacement cutter blade 12 into engagement with the cutter holder 30 to finish the cutter blade replacement procedure. When the replacement cutter blades 12 in the front chamber 22 are used up, the user can drive the control knob 49 to move the push block 46 forwards, thereby delivering 8 pcs replacement cutter blades 12 out of the cutter blade magazine 40 into the front chamber 22. According to this design, the front chamber 22 can accommodate 8 pcs replacement cutter blades 12, and the cutter blade magazine 40 can accommodate 24 pcs (or more) replacement cutter blades 12. Therefore, total 32 pcs (or more) replacement cutter blades 12 can be stored in the utility knife. Further, through the control knob 49, the user can move the push block 46 forwards or backwards to move replacement cutter blades 12 into position. This replacement cutter blade loading and replacing procedure is easy and convenient. When replacing the cutter blade, the user needs not to touch the replacement cutter blade. Therefore, the cutter blade replacing procedure is safe, eliminating potential injury accidence. Further, when the cutter blade magazine 40 is empty, the user can operate the safety button 55 to unlock the cutter blade magazine 40 for a replacement. After removal of the empty cutter blade magazine, a new cutter blade magazine 40 that is full of new replacement cutter blades 12 is then inserted into the rear chamber 25 of the housing 20. Because the user does not touch any replacement cutter blades 12 during loading of the cutter blade magazine 40, the invention eliminates potential injury.

A prototype of utility knife has been constructed with the features of FIGS. 1˜12. The utility knife functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A utility knife comprising:
a housing having a front chamber, an elongated hole in communication between said front chamber and the space outside said housing, a cutter blade outlet in communication between said front chamber and the space outside said housing, a rear chamber in communication with said front chamber, and an opening in communication between said rear chamber and the space outside said housing;
a cutter holder having a holder base mounted in said front chamber of said housing, and a suspension arm extending from said holder base to the outside of said housing through said elongated hole;
a cutter blade magazine inserted through said opening of said housing into said rear chamber, said cutter blade magazine having a cutter blade chamber, a sliding slot in communication between said cutter blade chamber and the space outside said cutter blade magazine, an elongated slot in communication between said cutter blade chamber and said rear chamber of said housing, an outlet in communication between said cutter blade chamber and said front chamber of said housing, and a push block mounted in said cutter blade chamber, said push block having a block body movably positioned in said cutter blade chamber of said cutter blade magazine, and a control knob extending from said block body and received in the sliding slot of said cutter blade magazine; and
an elastic member mounted in said rear chamber of said housing, said elastic member having a first end fastened to said housing and a second end inserted through said elongated slot of said cutter blade magazine into said cutter blade chamber.

2. The utility knife as claimed in claim 1, wherein said push block comprises a support arm extending from said block body, and a locating rod laterally extending from said support arm.

3. The utility knife as claimed in claim 1, wherein said housing comprises a stop flange disposed at one end of said opening for securing said cutter blade magazine.

4. The utility knife as claimed in claim 1, wherein said cutter blade magazine comprises a protruding portion; said housing comprises a short hole in communication between said rear chamber and the space outside said housing; said utility knife further comprises a safety button mounted in said rear chamber of said housing and extending out of said housing through said short hole, and a first spring member provided between said housing and said safety button for forcing said safety button against the protruding portion of said cutter blade magazine.

5. The utility knife as claimed in claim 4, further comprising a retaining member pivoted to said housing and swingable between a first position and a second position, and a second spring member supported between said housing and said retaining member, said retaining member having a guide face and an extension arm, said extension arm being stopped against said safety button when said guide face receives an external force to rotate said retaining member from said first position to said second position.

6. The utility knife as claimed in claim 1, wherein said push block comprises an elastically deformable positioning arm, said positioning arm having a protruding portion extending from a rear end thereof; said cutter blade magazine has a hole for receiving the protruding portion of said positioning arm.

7. The utility knife as claimed in claim 6, wherein said housing comprises a rib stopped against the protruding portion of said positioning arm of said push block.

8. The utility knife as claimed in claim 1, further comprising a first magnetic member mounted inside said housing between said front chamber and said rear chamber.

9. The utility knife as claimed in claim 1, further comprising a first spring plate mounted in said front chamber of said housing, said first spring plate having a front end fastened to said housing and a rear end terminating in an L-shaped transverse extension portion.

10. The utility knife as claimed in claim 1, wherein said cutter holder comprises a second magnetic member mounted in said holder base.

11. The utility knife as claimed in claim 1, further comprising a second spring plate mounted in said front chamber of said housing, said second spring plate having a rear end fastened to said housing and a front end terminating in a retaining portion.

12. The utility knife as claimed in claim 1, wherein said cutter blade chamber of said cutter blade magazine accommodates a plurality of cutter blades; said block body of said push block has a beveled surface stopped against the cutter blades.
